(19) United States
(12) Patent Application Publication
(10) Pub. No.: US 2023/0156272 A1
(43) Pub. Date: May 18, 2023

(54) AUDIOVISUAL DEVICE AND METHOD

(71) Applicants: Inventec (Pudong) Technology Corporation, Shanghai (CN); INVENTEC CORPORATION, Taipei (TW)

(72) Inventors: PO HSUAN HUANG, Taipei (TW); HAO-SHENG WANG, Taipei (TW); Trista Pei-Chun Chen, Taipei (TW); Kuo-Chi Ting, Taipei (TW)

(21) Appl. No.: 17/693,531

(22) Filed: Mar. 14, 2022

(30) Foreign Application Priority Data
Nov. 17, 2021 (CN) 202111361487.2

(51) Int. Cl. H04N 21/439; H04N 21/4728; H04N 21/44; G06F 3/16

(52) U.S. Cl. CPC H04N 21/4394; H04N 21/4728; H04N 21/44008; G06F 3/165

(57) ABSTRACT

An audiovisual device includes an input interface configured to receive a character indication signal, a display unit configured to display a video and output an audio signal of the video, wherein the video includes a plurality of characters, and the audio signal includes a plurality of audio tracks, and a processor configured to perform calculation on a motion waveform of each of the characters in the video and a plurality of sound waveforms of the audio tracks to generate a plurality of correlation coefficients, and determine a character audio track of each of the characters according to the correlation coefficients of each of the characters. The processor extracts a target character audio track corresponding to the character indication signal, and controls the display unit to adjust a relative volume between the target character audio track and other audio tracks among the audio tracks when receiving the character indication signal.

### CROSS-REFERENCE TO RELATED APPLICATIONS

This non-provisional application claims priority under 35 U.S.C. § 119(a) on Patent Application No(s). 202111361487.2 filed in China on Nov. 17, 2021, the entire contents of which are hereby incorporated by reference.

### BACKGROUND

### 1. Technical Field

This disclosure relates to an audiovisual device and method, especially to an audiovisual device and method displaying an audio track corresponding to a specific character.

### 2. Related Art

In recent years, the development of electronic devices has progressed significantly. More and more diversified electronic devices for watching videos have emerged, such as mobile phones, desktop computers, and TVs. With the development of the Internet, users may use electronic devices to watch videos on websites or video streaming platforms (such as YouTube and Netflix), and smart TVs have also emerged. However, currently, when a TV is playing a video, the sound is usually mixed sound. Therefore, users often have trouble in distinguishing which character the sound belongs to in a video.

Although the existing sound separation technique may be used to distinguish different sound sources in a video, a number and types of the sound sources in the video have to be obtained in advance before performing sound separation on the video. That is, current sound separation technique is unable to distinguish different sound sources in an unknown video.

### SUMMARY

Accordingly, this disclosure provides an audiovisual device and method without the need of knowing a number and types of the sound sources in advance, and may even distinguish different characters in a video as well as obtain sound tracks of corresponding characters to solve the problem of users not being able to distinguish which character the sound belongs to in a video.

According to one or more embodiment of this disclosure, an audiovisual device includes: an input interface configured to receive a character indication signal; a display unit configured to display a video and output an audio signal of the video, wherein the video includes a plurality of characters, and the audio signal includes a plurality of audio tracks; and a processor electrically connected to the input interface and the display unit, with the processor performing calculation on a motion waveform of each of the characters in the video and a plurality of sound waveforms of the audio tracks to generate a plurality of correlation coefficients, and determining a character audio track of each of the characters from the audio tracks according to the correlation coefficients of each of the characters; wherein when the processor receives the character indication signal, the processor selects a target character audio track according to the character corresponding to the character indication signal, and controls the display unit to adjust a relative volume between the target character audio track and other audio tracks among the audio tracks.

According to one or more embodiment of this disclosure, a video display method includes: obtaining a video and an audio signal of the video, with the video including a plurality of characters, and the audio signal including a plurality of audio tracks; performing calculation on a motion waveform of each of the characters in the video and a plurality of sound waveforms of the audio tracks to generate a plurality of correlation coefficients; determining a character audio track of each of the characters from the audio tracks according to the correlation coefficients of each of the characters; and selecting a target character audio track according to the character corresponding to a character indication signal, and adjusting a relative volume between the target character audio track and other audio tracks among the audio tracks when displaying the video and receiving a character indication signal.

In view of the above description, the audiovisual device and method of the present disclosure may perform calculation on a motion waveform of each of the characters in the video and a plurality of sound waveforms of the audio tracks to generate the plurality of correlation coefficients to determine the character audio track corresponding to the character, as well as play the target character audio track according to the character indication signal triggered by the user.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of an embodiment of an audiovisual device of the present disclosure;

FIG. 2 is a flow chart of an embodiment of a video display method of the present disclosure;

FIG. 3 is a configuration diagram of an embodiment of a sound separation model of the present disclosure;

FIG. 4 is a configuration diagram of an embodiment of an object identification model of the present disclosure;

FIG. 5 is a waveform diagram of an embodiment of a motion waveform and a sound waveform of the present disclosure; and

FIG. 6 is a schematic diagram of an embodiment of a display image of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

It will be understood that, although the terms “first,” “second,” etc., may be used herein to describe various elements, parts, areas, layers and/or portions, these elements, parts, areas, layers and/or portions should not be limited by these terms. These terms are only used to distinguish one element, part, area, layer and/or portion from another.

In addition, terms “comprise” and “include” describe the existence of features, areas, entire entities, steps, operations, elements and/or parts, but do not exclude the existence or adding one or more of other features, areas, entire entities, steps, operations, elements and/or parts.

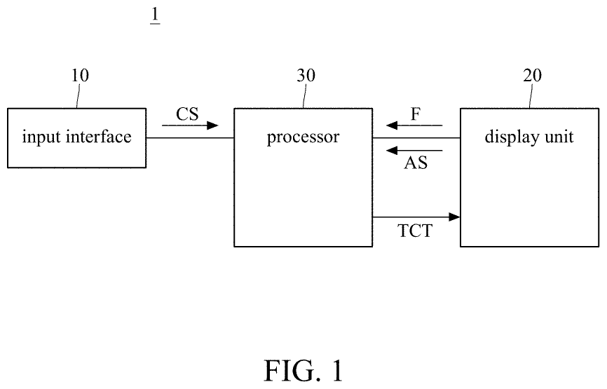

Please refer to FIG. 1, which is a block diagram of an embodiment of an audiovisual device of the present disclosure. As shown by FIG. 1, the audiovisual device 1 of the present disclosure includes an input interface 10, a display unit 20 and a processor 30. The input interface 10 is configured to receive a character indication signal CS. The display unit 20 is configured to display a video F and output an audio signal AS of the video F. The video F includes a plurality of characters, and the audio signal AS includes a plurality of audio tracks. The processor 30 is electrically connected to the input interface 10 and the display unit 20, and the processor 30 may select a target character audio track TCT according to the character corresponding to the character indication signal CS. The detail of the above content is described below.

In an embodiment, the audiovisual device of the present disclosure is a computer, the input interface 10 includes a keyboard and a mouse, the processor 30 is a central processing unit or other types of processors, and the display unit 20 is an organic light-emitting diode display, micro light-emitting diode display, light-emitting diode display or other types of displays. In another embodiment, the audiovisual device of the present disclosure is a touch device (for example, smart phone), the display unit 20 is a screen, the input interface 10 is a touch interface, the display unit 20 and the input interface 10 may be integrated into a touch screen for a user to touch and generates a touch signal accordingly. In other words, the character indication signal is a touch signal, the processor 30 is a central processing unit or other types of processors.

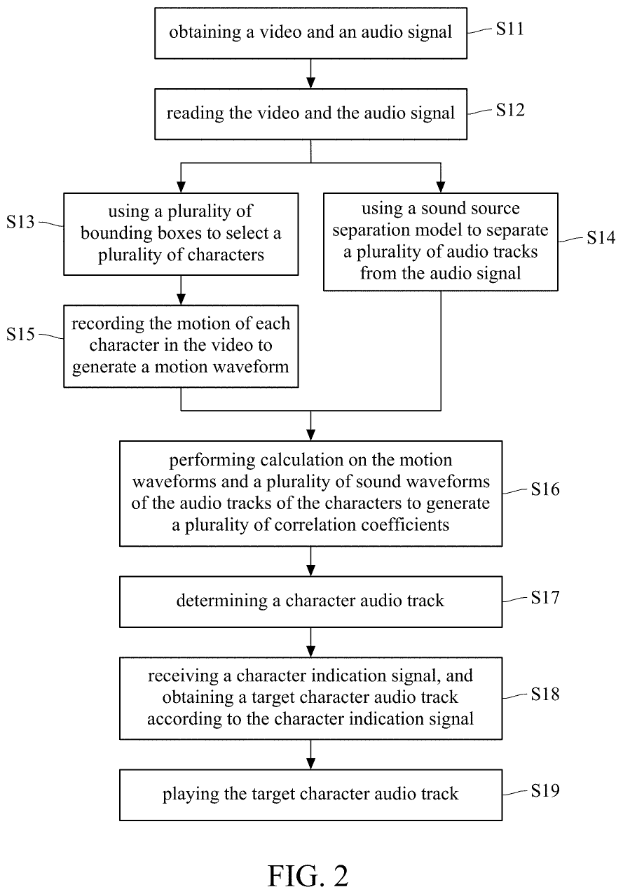

Please refer to FIG. 2, which is a flow chart of an embodiment of a video display method of the present disclosure. The following describes the video display method of the present disclosure which includes steps S11 to S19 as shown by FIG. 2, wherein the following description is made in reference with FIG. 1.

In step S11, the audiovisual device 1 of the present disclosure obtains the video F and the audio signal AS. The video F includes a plurality of display images, the plurality of display images record motions of a plurality of characters at different points of time. The audio signal AS includes character audio tracks, background audio tracks and other audio tracks corresponding to the characters. For example, please also refer to FIG. 6, a first character P1 plays a drum in the video F and drum sound is generated (the drum sound is the first character audio track corresponding to the first character P1), a second character P2 plays a guitar in the video F and guitar sound is generated (the guitar sound is the second character audio track corresponding to the second character P2), a third character P3 sings in the video F and singing sound is generated (the singing sound is the third character audio track corresponding to the third character P3), the background audio tracks are accompaniment music in the video F (the background audio tracks may be played from audio signal device or Bluetooth speakers of the computer), and other audio tracks may be the sound of traffic on the street outside. The video F and the audio signal AS may be pre-stored in a memory of the audiovisual device 1 of the present disclosure, or, the video F and the audio signal AS may be imported by the user from an external source (such as flash drive or cloud platform).

In step S12, the processor 30 reads the video F and the audio signal AS. When reading the video F and the audio signal AS, the processor 30 obtains the motion of each character in each display image as well as the audio track of the corresponding character, the background audio tracks and other audio tracks.

The processor 30 divides video processing of the video F into a first part and a second part. The first part (step S13) is character recognition, for recognizing every character in the video F; the second part (step S14) is sound source separation, for dividing the audio signal AS into the plurality of audio tracks. In an embodiment, the first part and the second part are performed by the processor 30 simultaneously. In another embodiment, the first part and the second part are performed by the processor 30 at different points of time.

In step S13, the processor 30 uses a plurality of bounding boxes to select (circle) these characters. After step S13 is completed, the processor 30 continues to perform step S15. Take FIG. 6 as an example, the bounding box B1 circles the first character P1, the bounding box B2 circles the second character P2, and the bounding box B3 circles the third character P3. In an embodiment, the selection of a plurality of bounding boxes is performed by using Yolo v3 convolutional neural network (CNN) and SORT algorithm. Yolo v3 convolutional neural network identifies a plurality of characters in a single display image in the video. Since Yolo v3 convolutional neural network performs identification on static image, SORT algorithm may be needed for performing identification. SORT algorithm detects each character in multiple display images according to the identification result of Yolo v3 convolutional neural network.

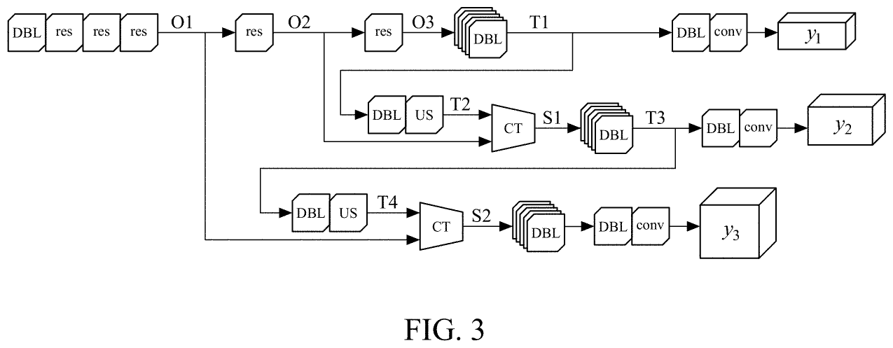

Please refer to FIG. 3 as well, wherein FIG. 3 illustrates Yolo v3 convolutional neural network including a plurality of residual layers RES, a plurality of darknet layers DBL (darknetconv2D_BN_Leaky, wherein BN is short for “Batch normalization”), a plurality of convolution layers CONV, the cascade layer CT and the upsampling layer US. Each of the darknet layers DBL includes the convolution layer CONV, the Batch normalization layer and rectified linear unit (ReLU). The processor 30 first generates corresponding image matrix IM according to a single display image, and performs feature extraction operation on each darknet layer DBL, each convolution layer CONV and each residual layer RES.

A matrix O1 is generated after the image matrix IM passes through one darknet layer DBL and three residual layers RES. The matrix O1 enters one residual layer RES and one cascade layer CT respectively, and a matrix O2 is generated after the matrix O1 passes through one residual layer RES. The matrix O2 enters one residual layer RES and one cascade layer CT respectively, and a matrix O3 is generated after the matrix O2 passes through one residual layer RES. A matrix T1 is generated after the matrix O3 passes through five darknet layers DBL. The matrix T1 enters one darknet layer DBL followed by the convolution layer CONV and one darknet layer DBL followed by the upsampling layer US. A matrix y1 is generated after the matrix T1 passes through one darknet layer DBL and one convolution layer CONV.

The matrix T2 is generated after the matrix T1 passes through one darknet layer DBL and the upsampling layer US. The matrix O2 and the matrix T2 are integrated into one matrix S1 after passing through one cascade layer CT. The matrix T3 is generated after the matrix S1 passes through five darknet layers DBL. The matrix T3 enters one darknet layer DBL followed by the convolution layer CONV and one darknet layer DBL followed by the upsampling layer US. An eigenmatrix y2 is generated after the matrix T3 passes through one darknet layer DBL and one convolution layer CONV.

A matrix T4 is generated after the matrix T3 passes through one darknet layer DBL and the upsampling layer US. The matrix T4 and the matrix O1 are integrated into one matrix S2 after passing through one cascade layer CT. An eigenmatrix y3 is generated after the matrix S2 passes through six darknet layers DBL and one convolution layer CONV.

The matrix sizes of the eigenmatrix y1, the eigenmatrix y2 and the eigenmatrix y3 are different. The processor 30 generates the bounding boxes B1˜B3 according to the eigenmatrix y1, the eigenmatrix y2 and the eigenmatrix y3, wherein the sizes of the bounding boxes B1˜B3 are different from each other. The processor 30 may use the bounding boxes B1˜B3 with different sizes to circle the first character P1, the second character P2 and the third character P3 with different sizes.

It should be noted that, Yolo v3 convolutional neural network speeds up the process of recognizing the first character P1, the second character P2 and the third character P3 by increasing the number of times of recognizing a plurality of characters in a plurality of display images of the video F. Yolo v3 convolutional neural network extracts distinctive image features (such as shape, color, face and body proportions) of the first character P1, the second character P2 and the third character P3 in the video F and uses them as the basis for performing recognition on the first character P1, the second character P2 and the third character P3. In addition to the first character P1, the second character P2 and the third character P3, other images of other characters and objects (such as cats and dogs) may also be inputted into Yolo v3 convolutional neural network, for Yolo v3 convolutional neural network to be able to recognize various characters and objects.

SORT algorithm includes two parts, one being intersection over union (IOU) matching, and the other being bounding box prediction of Kalman Filter. Take one bounding box (one of the bounding boxes B1˜B3) in a current display image of the video as an example, IOU matching is determining whether the bounding box of the current display image matches the bounding box predicted by Kalman Filter (which may be achieved by Kuhn-Munkres algorithm or Hungarian algorithm). If the bounding box of the current display image obtained by using IOU matching is determined by the processor 30 to be matching with the bounding box of the display image predicted by Kalman Filter, the processor 30 determines the bounding box of the current display image is correct, and Kalman Filter update its prediction status for Kalman Filter to predict the bounding box of the next display image. If the bounding box of the current display image obtained by using IOU matching is determined by the processor 30 to be not matching with the bounding box predicted by Kalman Filter, the processor 30 deletes the bounding box of the current display image. If the processor 30 detects a plurality of characters contained in the bounding box (for example, in addition to the first character P1, the bounding box B1 contains other characters), the processor 30 maintains the location of the original bounding box (for example, the bounding box B1 circling the first character), and the processor 30 establishes a plurality of bounding boxes for a plurality of characters. Kalman Filter updates its prediction status according to the plurality of bounding boxes and the original bounding box (for example, the bounding box B1), and predicts the original bounding box of the next display image and a plurality of bounding boxes.

The above embodiment uses the bounding box to select (circle) characters, but the present disclosure is not limited thereto. In another embodiment, the processor 30 may use point clouds with different colors to depict different characters (for example, the body shape of the first character is depicted with red point clouds, and the body shape of the second character is depicted with green point clouds), and uses dynamic graph convolutional neural network (CNN) to recognize each character. Dynamic graph convolutional neural network records the motion of the characters in each display image of the video F.

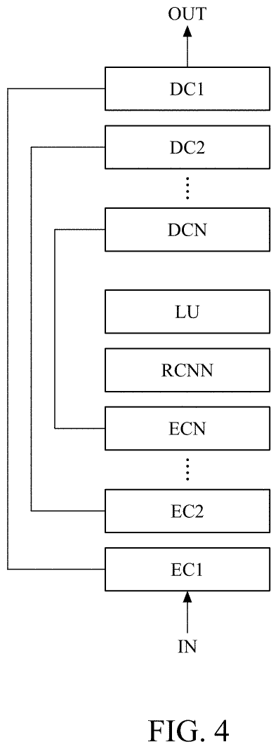

In step S14, the processor 30 uses a sound source separation model to separate the plurality of audio tracks from the audio signal AS. The processor 30 continues to perform step S16 after step S14 completes. In an embodiment, please refer to FIG. 4 as well, the sound source separation model is a Facebook Demucs model, data set is MusDB. Facebook Demucs model includes a plurality of convolutional coding layers EC1˜ECN, a plurality of convolutional decoding layers DC1˜DCN, a plurality of linear unit layers LU and long short-term memory (LSTM) recurrent neural network RCNN. Input IN is the audio signal AS, and output OUT is the plurality of audio tracks. The number of layers of the plurality of convolutional coding layers EC1˜ECN and the number of layers of the plurality of convolutional decoding layers DC1˜DCN are the same. The plurality of convolutional coding layers EC1˜ECN are connected to the plurality of convolutional decoding layers DC1˜DCN. For example, the convolutional coding layer EC1 is connected to the convolutional decoding layer DC1, the LSTM recurrent neural network and the linear unit layers are located between the convolutional decoding layers DCN and the convolutional coding layers ECN. Each of the convolutional coding layers EC1˜ECN and each of the convolutional decoding layers DC1˜DCN include a rectified linear layer and a gate linear unit (GLU). The convolutional coding layers EC1˜ECN perform encoding and feature extraction on the audio signal AS to generate a plurality of the eigenmatrices corresponding to the plurality of audio tracks. The plurality of convolutional decoding layers DC1˜DCN perform decoding on the plurality of the eigenmatrices corresponding to the plurality of audio tracks to generate the plurality of audio tracks (which includes the plurality of character audio tracks, the background audio tracks and other audio tracks). The LSTM recurrent neural network RCNN selectively stores and ignores/omits/abandons according to the character audio track of each character, the background audio tracks and other audio tracks in the current display image and the character audio track of each character, the background audio tracks and other audio tracks in the previous display image (for example, the character in the current display image makes drum sound from playing drums, the character in the previous display image does not make any sound since the character is asleep, and the LSTM recurrent neural network RCNN may ignore/omit/abandon the previous display image that does not make any sound). Through Facebook Demucs model, the plurality of character audio tracks and other audio tracks are successfully separated from the audio signal AS.

The sound source separation model in the above embodiment uses Facebook Demucs model as an example, but the present disclosure is not limited thereto. In another embodiment, the sound source separation model may be a Deezer: Spleeter model, the Deezer: Spleeter model applies Fourier transformation and convolutional neural network to the audio signal AS to generate a mask corresponding to each character audio track and background audio track. The processor 30 uses the mask corresponding to each character audio track and background audio track on the frequency spectrum of the audio signal AS to obtain the frequency spectrum of the plurality of character audio tracks and the frequency spectrum of the background audio tracks. The processor 30 performs inverse Fourier transformation on a plurality of character frequency spectrums and background frequency spectrum to obtain the plurality of character audio tracks and the background audio track.

In step S15, the processor 30 records the motion of each character in the video F. The processor 30 generates motion waveform according to the character motion of each of the characters. After step S15 completes, the processor 30 continues to perform step S16. Specifically, please refer to FIG. 6 again, the processor 30 uses the plurality of bounding boxes B1˜B3 to circle the first character P1, the second character P2 and the third character P3, wherein the bounding box B1 circles the drum, the bounding box B2 circles the guitar and the bounding box B3 circles the microphone. The first character P1 makes drum sound by using drum stick to hit the drumhead, the second character P2 plucks the strings of a guitar to make a guitar sound, and the third character P3 sings to the microphone. The processor 30 records the motion of the first character P1 hitting the drumhead with drum sticks in each display image to generate the motion waveform of the first character P1, the processor 30 records the motion of the second character P2 plucking the strings of the guitar in each display image to generate the motion waveform of the second character P2, and the processor 30 records the motion of the mouth and body rhythm of the third character P3 in each display image to generate the motion waveform of the third character P3.

In step S16, the processor 30 performs calculation on motion waveforms of each of the characters and sound waveforms of these the audio tracks in the video F to generate a plurality of correlation coefficients. For example, a plurality of first correlation coefficients are generated based on the motion waveform of the first character P1 and the plurality of sound waveforms of the plurality of the audio tracks, a plurality of second correlation coefficients are generated based on the motion waveform of the second character P2 and the plurality of sound waveforms of the plurality of the audio tracks, and a plurality of third correlation coefficients are generated based on the motion waveform of the third character P3 and the plurality of sound waveforms of the plurality of the audio tracks.

For example, the greater the amplitude of hitting/playing the instrument by the character, the louder the sound of the instrument is, resulting in the greater the amplitude of the sound waveform of the instrument; the faster the character hitting/playing the instrument, the rhythm of the instrument's sound becomes more rapid, resulting in the greater the frequency of the instrument's sound waveform. Similarly, the motion of the character plunking the string, the motion of the mouth of the character singing or body rhythm are all associated with the sound waveforms of the character audio tracks.

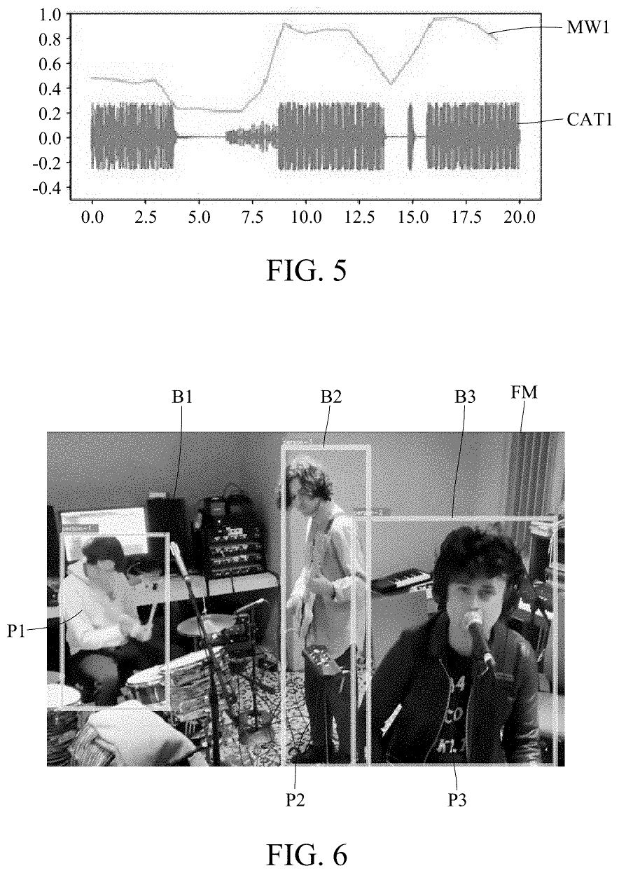

In step S17, the processor 30 determines the character audio track of each character from the audio tracks according to each of the character correlation coefficients. For example, the plurality of first correlation coefficients of the first character P1 for the audio tracks respectively are 0.8, 0.5, 0.7, 0.95. The processor 30 selects the audio track corresponding to the first correlation coefficient, which is 0.9, as the first character audio track of the first character P1. Please refer to FIG. 5 as well, wherein the horizontal axis is time (second), and vertical axis is the normalized amplitude. The sound wave of the audio track CAT1 corresponding to the first correlation coefficient that is 0.9 is close to the motion waveform of the first character P1MW1. The motion of first character P1 playing the drum in one display image may be reflected in the first character audio track. Similarly, the second character audio track of the second character P2 is also the audio track that the highest second correlation coefficient among the plurality of second correlation coefficients corresponds to. The third character audio track of the third character P3 is also the audio track that the highest third correlation coefficient among the plurality of third correlation coefficients. That is, when the correlation coefficient that the audio tracks corresponds to is higher, it means this audio track and the character are more likely to be associated with each other. The audio track with higher correlation coefficient may be regarded as the sound made by the character' motion in the video F. The processor 30 selects the audio track with high correlation coefficient as the character audio track corresponding to the character.

Specifically, the processor 30 may obtain the sequence of the first correlation coefficients through comparing the plurality of first correlation coefficients. The processor 30 obtains the highest first correlation coefficient according to the sequence of the first correlation coefficient, and uses the audio track corresponding to the highest first correlation coefficient as the first character audio track.

In step S18, when the processor 30 receives the character indication signal CS from the input interface 10, the processor 30 extracts target character audio track TCT from these character audio tracks according to the character corresponding to the character indication signal CS. Specifically, when the user is viewing the video F played by the display unit 20, the user uses the input interface 10 to send the character indication signal CS to the processor 30. The character indication signal CS indicates, for example, the bounding box B1, and the processor 30 determines that the bounding box B1 corresponds to the first character P1, and extracts the first character audio track from the plurality of character audio tracks according to the first character P1 circled by the bounding box B1. The processor 30 uses the first character audio track as the target character audio track TCT.

In step S19, the processor 30 controls the display unit 20 to adjust the relative volume between the target character audio track TCT and other audio tracks. In this embodiment, the processor 30 controls the display unit 20 to only output the target character audio tracks (for example, the first character audio track) and to not output the second character audio track, the third character audio track and the background audio tracks. That is, the processor 30 controls the display unit 20 to maintain the volume of the first character audio tracks, and lower the volumes of the second character audio tracks, the third character audio tracks and the background audio tracks to zero. Or, in another embodiment, the processor 30 controls the display unit 20 to not output the target character audio track (for example, the first character audio track), and to output the second character audio track, the third character audio track and the background audio tracks. That is, the processor 30 controls the display unit 20 to lower the volume of the first character audio track, and maintain the volumes of the second character audio track, the third character audio track and the background audio tracks. Or, in another embodiment, the processor 30 controls the display unit 20 to raise the volume of target character audio track (for example, the first character audio track) and lower the volumes of the second character audio track, the third character audio track and the background audio tracks.

Please refer to FIG. 6, which is a schematic diagram of an embodiment of a display image of the present disclosure. As shown by FIG. 6, the display image FM has the bounding boxes B1˜B3, wherein the bounding boxes B1˜B3 respectively circles the first character P1, the second character P2 and the third character P3. The colors of the bounding boxes B1˜B3 may be different from each other, and the marks of the bounding boxes B1˜B3 may be different from each other. Through different colors and marks, the user may easily distinguish between the first character P1, the second character P2 and the third character P3. In an embodiment, when the viewer is watching the video F, the user may touch the first character P1 on the touch screen displaying the display image FM, and the processor 30 controls the display unit 20 to play the first character audio track. In another embodiment, when the viewer is watching the video F, the user may click the first character P1 on the organic light-emitting diode display device displaying the display image FM, and the processor 30 controls the display unit 20 to play the first character audio track.

In view of the above description, the audiovisual device and method of the present disclosure may perform calculation on a motion waveform of each of the characters in the video F and a plurality of sound waveforms of the audio tracks to generate the plurality of correlation coefficients to determine the character audio track corresponding to the character, as well as play the target character audio track TCT according to the character indication signal triggered by the user.

What is claimed is:

1. An audiovisual device, comprising:
an input interface configured to receive a character indication signal;
a display unit configured to display a video and output an audio signal of the video, wherein the video includes a plurality of characters, and the audio signal includes a plurality of audio tracks; and
a processor electrically connected to the input interface and the display unit, with the processor performing calculation on a motion waveform of each of the characters in the video and a plurality of sound waveforms of the audio tracks to generate a plurality of correlation coefficients, and determining a character audio track of each of the characters from the audio tracks according to the correlation coefficients of each of the characters;
wherein when the processor receives the character indication signal, the processor selects a target character audio track according to the character corresponding to the character indication signal, and controls the display unit to adjust a relative volume between the target character audio track and other audio tracks among the audio tracks.

2. The audiovisual device according to claim 1, wherein the processor uses a sound source separation model to separate the audio signal into the plurality of audio tracks, and a plurality of voice prints of the audio tracks are different from each other, records a character motion of each of the characters in the video, and generates the motion waveform according to the character motion of each of the characters.

3. The audiovisual device according to claim 1, wherein the processor maintains a volume of the target character audio track, and adjusts a volume of the other audio tracks among the audio tracks to 0.

4. The audiovisual device according to claim 1, wherein the processor uses a plurality of bounding boxes to select the characters, selects a corresponding bounding box from the bounding boxes according to the character indication signal, and extracts the target character audio track from the character audio tracks according to the character of the corresponding bounding box.

5. The audiovisual device according to claim 1, wherein the input interface is a touch interface, and the character indication signal is a touch signal.

6. A video display method, comprising:
obtaining a video and an audio signal of the video, with the video including a plurality of characters, and the audio signal including a plurality of audio tracks;
performing calculation on a motion waveform of each of the characters in the video and a plurality of sound waveforms of the audio tracks to generate a plurality of correlation coefficients;
determining a character audio track of each of the characters from the audio tracks according to the correlation coefficients of each of the characters; and
selecting a target character audio track according to the character corresponding to a character indication signal, and adjusting a relative volume between the target character audio track and other audio tracks among the audio tracks when displaying the video and receiving a character indication signal.

7. The video display method according to claim 6, further comprising:
using a sound source separation model to separate the audio signal into the plurality of audio tracks, with a plurality of voice prints of the audio tracks being different from each other; and
recording a character motion of each of the characters in the video, and generating the motion waveform according to the character motion of each of the characters.

8. The video display method according to claim 6, further comprising:
maintaining a volume of the target character audio track, and adjusting a volume of the other audio tracks among the audio tracks to 0.

9. The video display method according to claim 6, further comprising using a plurality of bounding boxes to select the characters, wherein selecting the target character audio track comprises:
selecting a corresponding bounding box from the bounding boxes according to the character indication signal; and
extracting the target character audio track from the character audio tracks according to the character of the corresponding bounding box.

10. The video display method according to claim 6, wherein the character indication signal is a touch signal.
